(19) United States
(12) Patent Application Publication
(10) Pub. No.: US 2020/0298355 A1
(43) Pub. Date: Sep. 24, 2020

(54) WORKPIECE FIXING JIG

(71) Applicant: OKUMA CORPORATION, Niwa-Gun (JP)

(72) Inventor: Tomomi IDO, Niwa-Gun (JP)

(73) Assignee: OKUMA CORPORATION, Niwa-Gun (JP)

(21) Appl. No.: 16/812,785

(22) Filed: Mar. 9, 2020

(30) Foreign Application Priority Data
Mar. 19, 2019 (JP) 2019-051533

(51) Int. Cl. B23Q 1/03

(52) U.S. Cl. CPC B23Q 1/03

(57) ABSTRACT

A workpiece fixing jig for fixing a workpiece to a table and/or a pallet of a machine tool includes a base plate, a support block, a bolt, and a drop prevention unit. The base plate is clamped or unclamped to the table and/or the pallet. The support block is disposed upright on the base plate. The support block has a placement surface for the workpiece on a top surface of the support block. The bolt is housed in the support block to be movable up and down. The bolt is projected from the placement surface to be screwable into a lower surface of the workpiece. The drop prevention unit prevents a drop of the bolt from the inside of the support block.

### BACKGROUND OF THE INVENTION

This application claims the benefit of the Japanese Patent Application Number 2019-051533 filed on Mar. 19, 2019, the entirety of which is incorporated by reference.

### FIELD OF THE INVENTION

The disclosure relates to a workpiece fixing jig used to fix a workpiece on a table and/or a pallet of a machine tool.

### RELATED ART

To process a workpiece by a machine tool, the workpiece is fixed on a pallet and/or a table using a jig, such as an angle plate. For example, JP-A-2006-142419 discloses a mounting auxiliary base where a mounting tool body to which a workpiece is mounted using a fastening member, such as a damper, is coupled to a base body via a plurality of positioning members and the base body is configured to be mounted to a pallet with bolts.

However, a plurality of processes are required for a workpiece which has a complicated shape and needs multi-surface machining, since arrangement change, such as a change of a posture of a workpiece and a position of a jig, is required. The arrangement change leads to a mounting error of the workpiece or an extra time for arrangement change, which causes lowering production efficiency. JP-A-2018-62029 describes a clamp system in which a screw shaft portion disposed in a pillar-shaped support body is screwed with a lower surface of a workpiece to make the pillar-shaped support body be attracted and fixed to a magnetic fixing device.

The above-described conventional clamp system fixes the lower surface of the workpiece. Therefore, simultaneous multi-surface machining can be performed, and the mounting error and the time taken for arrangement change decrease. Thus improvement in production efficiency can be expected. However, the use of the magnetic fixing device causes increasing of a size of the device and its weight, resulting in a rise in cost.

An object of the disclosure is to provide a workpiece fixing jig that ensures achieving fixation of a workpiece which leads to improvement in production efficiency with a simple configuration at a low cost.

### SUMMARY

In order to achieve the above-described object, a workpiece fixing jig for fixing a workpiece to a table or a pallet of a machine tool is provided. According to a first aspect of the disclosure, the workpiece fixing jig includes a base plate, a support block, a bolt, and a drop prevention unit. The base plate is clamped or unclamped to the table or the pallet. The support block is disposed upright on the base plate and has a placement surface for the workpiece on a top surface of the support block. The bolt is housed in the support block to be movable up and down and is projected from the placement surface to be screwable into a lower surface of the workpiece. The drop prevention means prevents the bolt from dropping from the inside of the support block.

A workpiece fixing jig according to a second aspect of the disclosure, which is in the first aspect of the disclosure, the drop prevention means includes a stopper plate and a nut. The stopper plate includes a penetrating portion where the bolt penetrates upward. The nut is screwed with the bolt above the stopper plate.

A workpiece fixing jig according to a third aspect of the disclosure, which is in the first aspect or the second aspect of the disclosure, a communication hole, which communicates with the inside of the support block and penetrates through the base plate, is formed under the bolt. A clamped portion for conveyance is provided on a side surface of the base plate.

According to the first aspect of the disclosure, the bolt is screwed into the lower surface of the workpiece without a risk of dropping to ensure fixing the workpiece. Accordingly, simultaneous multi-surface machining can be performed, and the fixation of the workpiece which leads to improvement in production efficiency can be achieved with a simple configuration at a low cost.

According to the second aspect of the disclosure, in addition to the effect of the first aspect, the drop prevention means is easily formed, because it includes the stopper plate and the nut.

According to the third aspect of the disclosure, in addition to the effects of the first aspect and the second aspect, the communication hole is formed to penetrate through the base plate under the bolt and the clamped portion for conveyance is provided on the side surface of the base plate. Therefore, with an industrial robot or the like, fixing the workpiece to the workpiece fixing jig, releasing the fixation, and conveying the workpiece to the table and/or the pallet can be automatically performed, and thus an application to an automatic machining line becomes possible.

### BRIEF DESCRIPTION OF THE DRAWINGS

FIG. 1 is a perspective view of a workpiece fixing jig.

FIG. 2A illustrates a front surface of the workpiece fixing jig.

FIG. 2B illustrates a planar surface of the workpiece fixing jig.

FIG. 2C illustrates a side surface of the workpiece fixing jig.

FIG. 3 is an enlarged cross-sectional view of the workpiece fixing jig taken along the line A-A of FIG. 2A.

FIG. 4 is a perspective view of the workpiece fixing jig to which a workpiece is fixed.

FIG. 5A illustrates a front surface of the workpiece fixing jig.

FIG. 5B illustrates a planar surface of the workpiece fixing jig.

FIG. 5C illustrates a cross-sectional surface of the workpiece fixing jig taken along the line B-B.

FIG. 6 is a perspective view in a state where the workpiece fixing jig is placed on a temporary placement table.

FIG. 7 is a front view in a state where the workpiece fixing jig is placed on the temporary placement table.

FIG. 8 is a cross-sectional view taken along the line C-C of FIG. 7.

### DETAILED DESCRIPTION

The following describes embodiments of the disclosure based on the drawings.

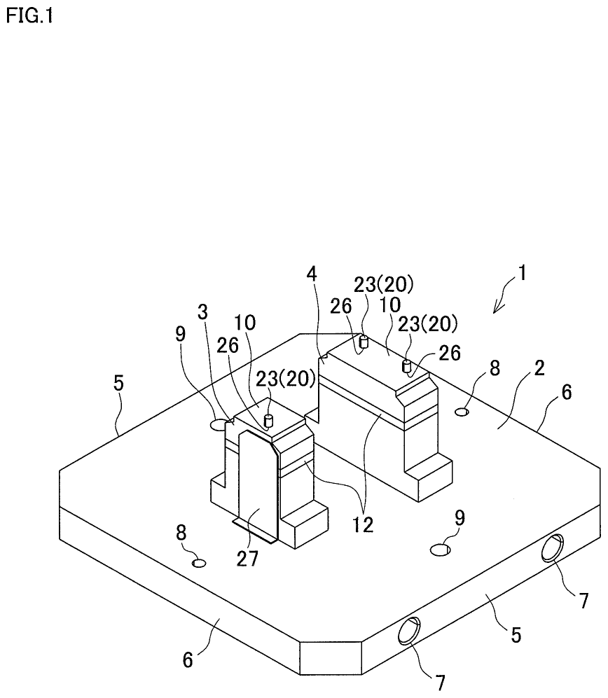

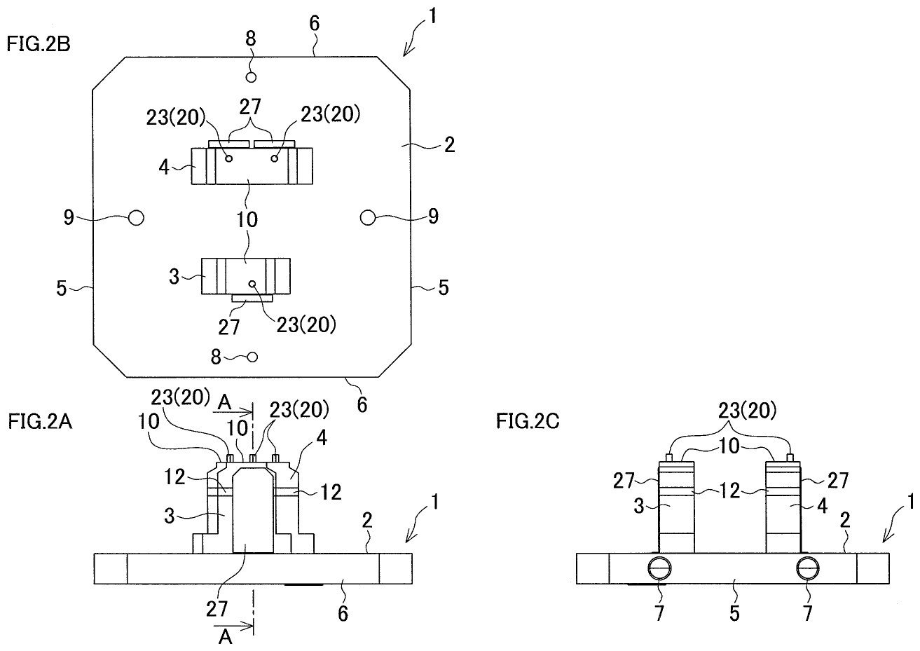

FIG. 1 is a perspective view illustrating one example of a workpiece fixing jig. FIG. 2A to FIG. 2C are respective explanatory views of the workpiece fixing jig. FIG. 2A illustrates a front surface, FIG. 2B illustrates a planar surface, and FIG. 2C illustrates a side surface.

A workpiece fixing jig 1 includes a base plate 2 and two supports blocks, which are a first support block 3 and a second support block 4, fixed to a top surface of the base plate 2.

The base plate 2 has a square shape in plan view whose corner portions are chamfered and includes a pair of parallel first side surfaces 5, 5, and a pair of parallel second side surfaces 6, 6 perpendicular to the first side surfaces 5, 5. A pair of conveyance holes 7, 7 are formed in the respective first side surfaces 5, 5. Additionally, a pair of temporary placement holes 8, 8 are each formed to penetrate in an up-down direction in edges of the second side surfaces 6, 6 and are used for temporary placement to a temporary placement table 40 described later. Furthermore, a pair of positioning holes 9, 9 are formed to penetrate in the up-down direction in edges of first side surfaces 5, 5. The holes are used for mounting the workpiece fixing jig to a base jig disposed in a pallet and a table.

The first support block 3 and the second support block 4 are arranged in a direction parallel to the second side surface 6 at a predetermined interval in a direction along the first side surface 5. The first support block 3 and the second support block 4 have identical heights, and have respective placement surfaces 10 which are formed parallel to a top of surface of the base 2.

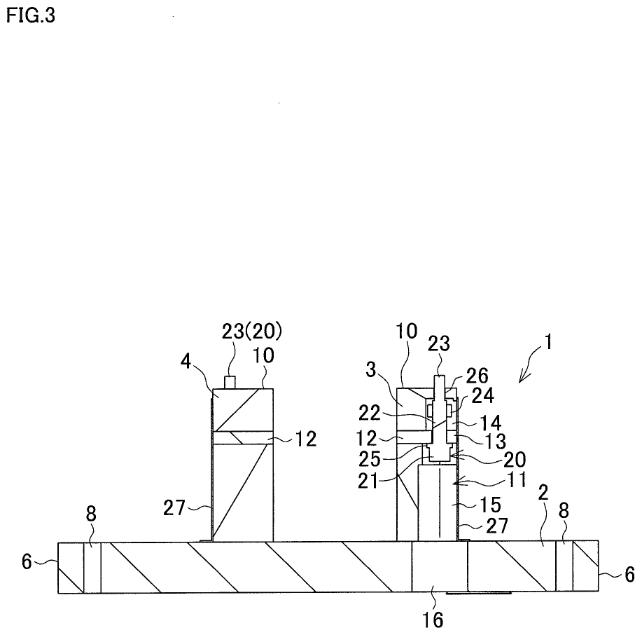

As illustrated in FIG. 3, the first support block 3 includes a housing hollow portion 11 in the up-down direction with closed top opening to the second side surface 6 side. A stopper plate 12 is disposed slightly upward with respect to an intermediate portion of the first support block 3 to be incorporated parallel to the placement surface 10 to partition an inside of the housing hollow portion 11 divided into up and down. A U-shaped groove 13 opening to the second side surface 6 side is formed on the stopper plate 12 inside the housing hollow portion 11. The housing hollow portion 11 is divided into up and down between which the stopper plate 12 is interposed and an upper hollow portion 14 and a lower hollow portion 15 has widths wider than that of the U-shaped groove 13 and each portion communicates with the U-shaped groove 13.

A bolt 20 having a hexagonal hole at a head 21 is held in the housing hollow portion 11. The bolt 20 includes a large-diameter first screw portion 22 at an intermediate portion and a small-diameter second screw portion 23 at a distal end, and a nut 24 is screwed with the first screw portion 22. Here, with the nut 24 positioned in the upper hollow portion 14 and the head 21 and a washer 25 positioned in the lower hollow portion 15, the first screw portion 22 is penetrated into the U-shaped groove 13. The bolt 20 is held so as to be oriented upward in a state where the nut 24 abuts on the stopper plate 12 and thus a downward drop is prevented. A through-hole 26 opening to the placement surface 10 is formed in the first support block 3 on an extended line of the upper side of the second screw portion 23.

Here, when the bolt 20 with the nut 24 is positioned at an upper side part of the first screw portion 22, the second screw portion 23 is not projected upward from the through-hole 26 while the nut 24 contacts the stopper plate 12. On the other hand, pressing up the bolt 20 until the washer 25 abuts on the stopper plate 12 makes the second screw portion 23 project upward from the through-hole 26. A cover 27 to obstruct the housing hollow portion 11 is screwed to a side surface of the first support block 3.

Similarly to the first support block 3, the second support block 4 also includes the housing hollow portion 11 and the bolt 20 similarly to the first support block 3, and here, the two sets are arranged side by side in a direction along the second side surface 6 and the covers 27, 27 are screwed corresponding to the respective housing hollow portions 11, 11.

Accordingly, on the placement surfaces 10, 10 of the first support blocks 3 and the second support block 4, the second screw portions 23 of the bolts 20 can appear at the three positions.

On the other hand, at the mounting positions for the first support block 3 and the second support block 4 in the base plate 2, communication holes 16 communicating with the respective housing hollow portions 11 in the up-down direction and penetrating through the base plate are formed.

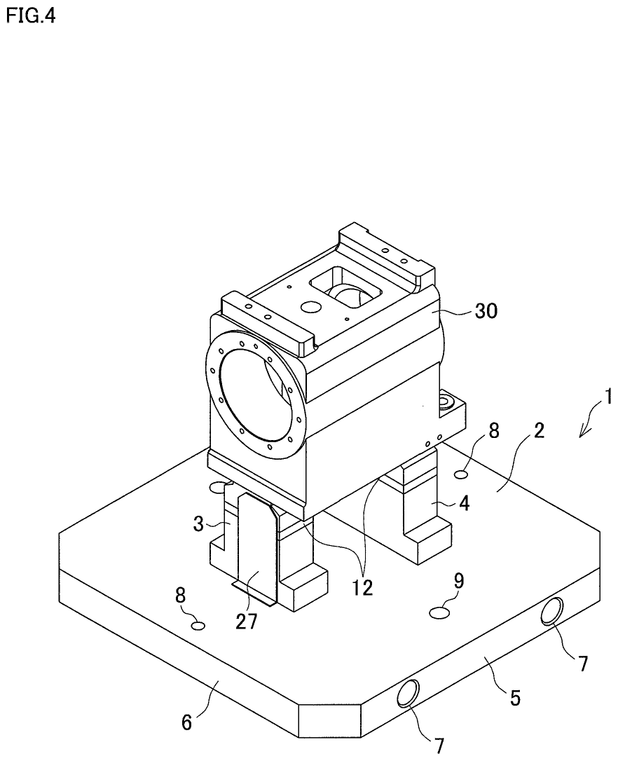

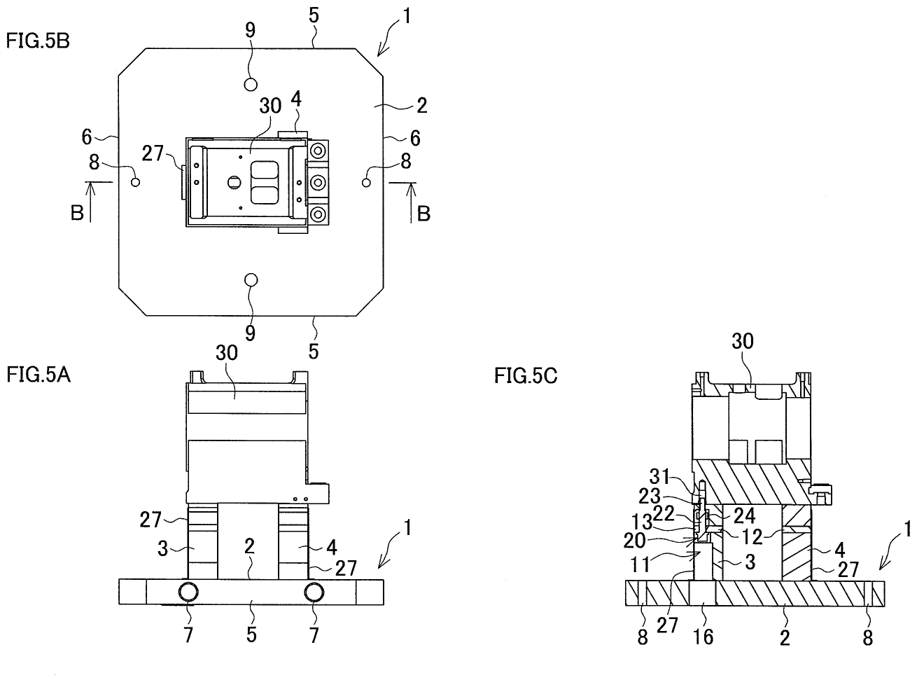

In the workpiece fixing jig 1 configured as described above, screw-holes 31 with which the second screw portions 23 can be screwed corresponding to the respective through-holes 26 in the first support block 3 and the second support block 4 are preliminarily formed in the lower surface of a workpiece 30 illustrated as FIG. 4 and FIG. 5A to 5C. The workpiece 30 is placed across the placement surfaces 10, 10 of the first support block 3 and the second support block 4 with the respective screw-holes 31 matched with the through-holes 26. With the cover 27 removed, after a hexagonal wrench or the like is inserted into each housing hollow portion 11, a rotating operation of the bolt 20 is performed, and the second screw portion 23 is screwed into each screw-hole 31 of the workpiece 30. Then, as illustrated in FIG. 4 and FIG. 5A to 5C, the workpiece 30 is fixed on the first support block 3 and the second support block 4. Since the front and rear, the right and left, and the top surface excluding the lower surface of the workpiece 30 are exposed in the state, by placing the base plate 2 on, for example, the pallet and by clamping the base plate 2, the simultaneous multi-surface machining can be performed without arrangement change.

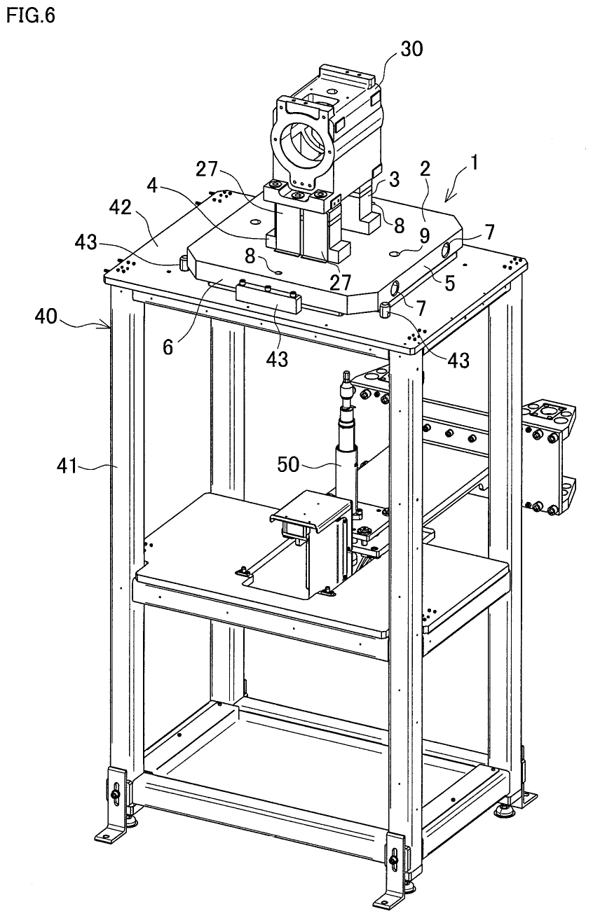

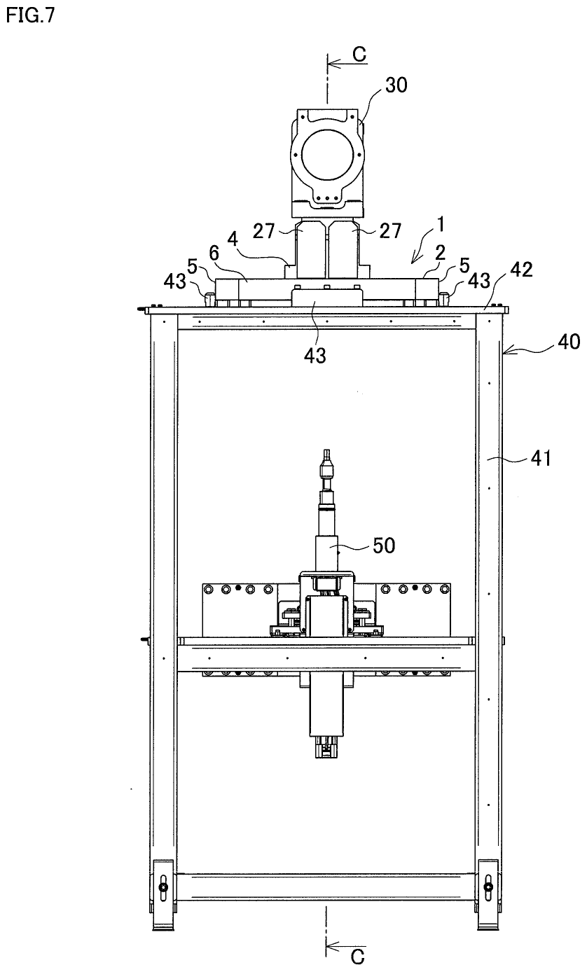

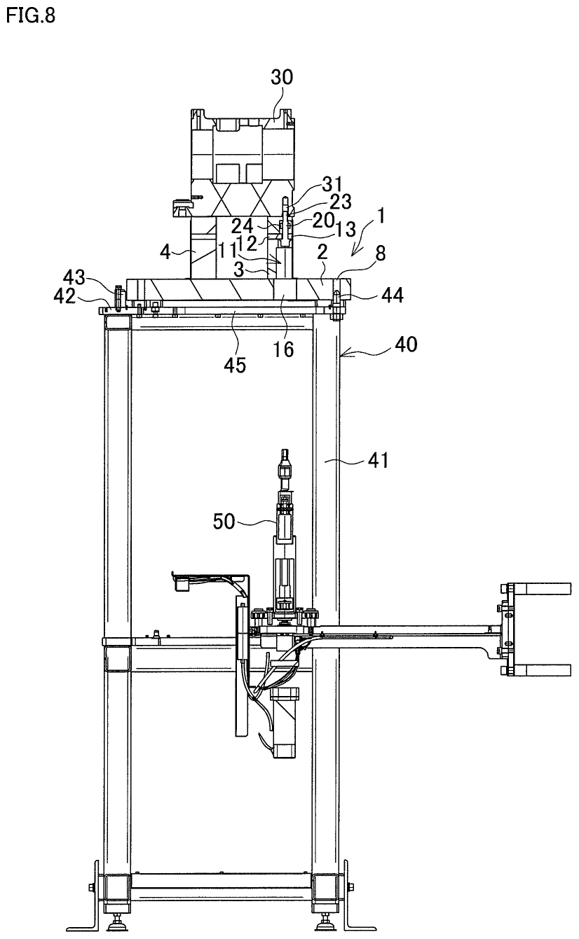

To use the workpiece fixing jig 1 for an automatic machining line, the temporary placement table 40 as illustrated in FIG. 6 to FIG. 8 is used. The temporary placement table 40 has a top board 42 on a top of a square-box-shaped frame 41. Positioning members 43, 43, and so on are abutted on the first side surfaces 5 and the second side surfaces 6 of the base plate 2 of the workpiece fixing jig, and are disposed upright on the top board 42. Positioning bolts 44 corresponding to the temporary placement holes 8, 8 of the base plate 2 are disposed to protrude upward. An opening 45 to open the communication hole 16 is formed underneath the communication hole 16 in the top board 42.

Accordingly, to fix the workpiece 30 to the workpiece fixing jig 1, the base plate 2 is positioned on the top board 42 of the temporary placement table 40 with the positioning members 43 and the positioning bolts 44. With the workpiece 30 placed on the first support block 3 and the second support block 4, using robot hands to which nutrunners 50 are mounted, socket bits mounted to the nutrunners 50 are moved upward from the lower portion of the top board 42. The socket bits are caused to enter the housing hollow portions 11 in the first support block 3 and the second support block 4 in order via the opening 45 and the bolts 20 are fastened to ensure fixing the workpiece 30. The nutrunner 50 has a torque value management function which enables it to fasten the bolt 20 with an appropriate torque and to determine whether the fastening is completed.

With the workpiece fixing jig 1 to which the workpiece 30 is fixed, a pair of conveyance pins disposed in the respective robot hands are inserted into and locked to the pair of conveyance holes 7, 7, which are disposed in the respective first side surfaces 5 of the base plate 2, using an industrial robot to which a pair of robot hands are mounted. Thus, the base plate 2 is clamped and can be conveyed to a machining station without further processes. At the machining station, all surface excluding the lower surface of the workpiece 30 are exposed by placing the base plate 2 on the pallet and/or the table and clamping the base plate 2, thus the simultaneous multi-surface machining can be performed. After terminating the machining, the workpiece fixing jig 1 is removed by using the robot hands similarly and is set to the temporary placement table 40, which allows the nutrunners 50 to remove the workpiece.

The workpiece fixing jig 1 with the above-described configuration includes the base plate 2, the first support block 3 and the second support block 4, the bolts 20, and the stopper plates 12 and the nuts 24 (drop prevention means). The base plate 2 is clamped or unclamped to the table or the pallet. The first support block 3 and the second support block 4 are disposed upright on the base plate 2 and have the placement surfaces 10 for the workpiece 30 on the top surfaces. The bolts 20 are housed in the first support block 3 and the second support block 4 to be movable up and down. The bolts 20 are projected from the placement surfaces 10 to be screwable into the lower surface of the workpiece 30. The stopper plates 12 and the nuts 24 prevent the bolts 20 from dropping from the insides of the first support block 3 and the second support block 4. Thus, the bolts 20 are screwed into the lower surface of the workpiece 30 without a risk of dropping to ensure fixing the workpiece 30. Accordingly, the simultaneous multi-surface machining can be performed, and the fixation of the workpiece 30 leading to improvement in production efficiency can be achieved with a simple configuration at a low cost.

Especially here, the drop prevention means includes the stopper plate 12 and the nut 24. The stopper plate 12 includes the U-shaped groove 13 (penetrating portion) where the bolt 20 penetrates upward and the nut 24 is screwed with the bolt 20 above the stopper plate 12. Accordingly, the drop prevention means can be easily formed.

Moreover, the communication holes 16, which communicates with the insides of the first support blocks 3 and the second support blocks 4 and penetrates through the base plate 2, are formed under the bolts 20. The conveyance holes 7 (clamped portions) for conveyance are provided on the side surfaces of the base plate 2. Therefore, using with an industrial robot or the like, fixing the workpiece 30 to the workpiece fixing jig 1, releasing the fixation, and conveying the workpiece 30 to the table and/or the pallet can be automatically performed, and thus an application to an automatic machining line becomes possible.

The number of support blocks and the structure of the support blocks are not limited to the above-described configurations, one support block may be disposed with a plurality of bolts, or three or more support blocks may be disposed with a bolt provided in each block. Depending on the shape of the workpiece, a plurality of support blocks having different heights can be used.

Additionally, when the penetrating portion disposed in the stopper plate is configured as the U-shaped groove in the drop prevention means, the bolt can be removed from and entered into the side surface of the support block and working efficiency to fix the workpiece is more improved. However, the penetrating portion is not limited to the groove and may be a through-hole where the bolt penetrates. The retention to the stopper plate needs not be the nut, and other members, such as a circlip or a pin, may be used. The housing hollow portion may be opened to another surface.

Furthermore, the clamped portion is not limited to the conveyance hole with the above-described configuration and appropriately changeable depending on a structure of the conveyance means side, such as the industrial robot.

It is explicitly stated that all features disclosed in the description and/or the claims are intended to be disclosed separately and independently from each other for the purpose of original disclosure as well as for the purpose of restricting the claimed invention independent of the composition of the features in the embodiments and/or the claims. It is explicitly stated that all value ranges or indications of groups of entities disclose every possible intermediate value or intermediate entity for the purpose of original disclosure as well as for the purpose of restricting the claimed invention, in particular as limits of value ranges.

What is claimed is:

1. A workpiece fixing jig used for fixing a workpiece to a table or a pallet of a machine tool, the workpiece fixing jig comprising:
a base plate clamped or unclamped to the table or the pallet;
a support block disposed upright on the base plate, the support block having a placement surface for the workpiece on a top surface of the support block;
a bolt housed in the support block to be movable up and down, the bolt being projected from the placement surface to be screwable into a lower surface of the workpiece; and
a drop prevention unit that prevents the bolt from dropping from the inside of the support block.

2. The workpiece fixing jig according to claim 1, wherein
the drop prevention unit includes a stopper plate and a nut, the stopper plate including a penetrating portion through which the bolt penetrates upward, the nut being screwed with the bolt above the stopper plate.

3. The workpiece fixing jig according to claim 1, wherein
a communication hole that communicates with the inside of the support block is formed to penetrate under the bolt through the base plate, a clamped portion for conveyance being provided on a side surface of the base plate.

4. The workpiece fixing jig according to claim 2, wherein
a communication hole that communicates with the inside of the support block is formed to penetrate under the bolt through the base plate, a clamped portion for conveyance being provided on a side surface of the base plate.
